(19) United States
(12) Patent Application Publication
(10) Pub. No.: US 2015/0340913 A1
(43) Pub. Date: Nov. 26, 2015

(54) LOW-COG PERMANENT MAGNET MOTOR

(71) Applicant: DELTA ELECTRONICS, INC., Taoyuan County (TW)

(72) Inventors: Yuan-Hung CHO, Taoyuan County (TW); Chien-Ho LEE, Taoyuan County (TW); Chao-Hsing KANG, Taoyuan County (TW); Tsung-Yin LEE, Taoyuan County (TW)

(21) Appl. No.: 14/718,790

(22) Filed: May 21, 2015

Related U.S. Application Data
(60) Provisional application No. 62/001,898, filed on May 22, 2014.

(51) Int. Cl. H02K 1/16; H02K 1/27

(52) U.S. Cl. CPC H02K 1/16; H02K 1/2786

(57) ABSTRACT

A low-cog permanent magnet motor includes a stator and a rotor. The stator includes a plurality of bobbins. The bobbins are arranged in a radial pattern. Each of the bobbins forms a pole shoe, and the pole shoes are arranged in a ring shape. The rotor includes an outer sleeve which encloses the stator and includes an even number of permanent magnets attached to an inner wall of the outer sleeve. The permanent magnets are arranged in a ring shape. Each of the pole shoes includes an outer curved surface facing an inner wall of the outer sleeve and includes an inner arc surface opposite to the outer arc surface, and a radius of the outer arc surface is smaller than a radius of the inner arc surface. A cogging torque is reduced by changing a shape of the pole shoe.

### CROSS-REFERENCE TO RELATED APPLICATION

This patent application claims the benefit of U.S. Provisional Patent Application No. 62/001,898, filed May 22, 2014, which is incorporated by reference herein.

### BACKGROUND

1. Technical Field

The present invention relates to a permanent magnet motor and, in particular, to a low-cog permanent magnet motor which reduces a cogging torque by changing a shape of a pole shoe or a permanent magnet.

2. Related Art

In conventional motors, a pole tooth, surrounded by a coil, and a magnetic pole portion are disposed on a stator and a rotor, respectively. The rotor rotates by electromagnetic interactions between the coil and the magnetic pole portion. During an operation process of the motor, when the pole tooth departs from the magnetic pole portion, the magnetic attraction therebetween resists the rotational inertia and therefore moves the rotor in a reverse direction, thereby producing a cogging torque. However, in conventional techniques, shapes of magnets and bobbins are not considered to be important, only a slot/pole number is utilized to improve the cogging torque problem, which results in a limited effect on cogging torque deduction. Therefore, in the case of high requirements for vibrations or low shakings at an extremely low rotation speed and a null speed, the conventional motor cannot meet the requirements.

In order to solve the above-mentioned problems, there are quite some methods, and “slot skew” and “magnet skew” are the most frequently used methods.

Although a slot skew can effectively improve the cogging torque problem, it results in higher requirements for a silicon steel plate progressive die, a manufacturing process and a manufacturing apparatus. Furthermore, since skewed bobbins cause the bobbin openings to be un-perpendicular, it is more difficult to wind the coils

The “slot skew” is one of the most frequently used methods for reducing the cogging torque, and “segmented magnet” and “integral-type oblique magnet” are the most frequently applied approaches to achieve the slot skew. The “segmented magnet” results in a complicated assembly process and a long production time, and the effect of reducing the cogging torque is compromised for the reason that an upper and lower magnet of the same polarity are attached to staggered positions. As to the integral-type oblique magnet, there are more difficulties in fabricating a die mold and a magnetizer for manufacturing the integral-type oblique magnet, and a skew angle is also limited.

In view of the foregoing, the inventor made various studies to overcome the above-mentioned problems to realize the improvements, on the basis of which the present disclosure is accomplished.

### BRIEF SUMMARY

The present invention provides a low-cog permanent magnet motor which reduces a cogging torque by changing a shape of a pole shoe or a permanent magnet.

The present invention provides a low-cog permanent magnet motor which comprises a stator and a rotor. The stator includes a plurality of bobbins, the bobbins are arranged in a radial pattern, an end portion of each of the bobbins forms a pole shoe, and the pole shoes are arranged in a ring shape. The rotor includes an outer sleeve which encloses the stator and includes an even number of permanent magnets attached to an inner wall of the outer sleeve. The permanent magnets are arranged in a ring shape. Each of the pole shoes includes an outer curved surface facing the inner wall of the outer sleeve and includes an inner arc surface opposite to the outer arc surface, and a radius of the outer arc surface is smaller than a radius of the inner arc surface.

By changing a shape of a pole shoe or a permanent magnet, the low-cog permanent magnet motor weakens the magnetic field of an edge of the permanent magnet, thereby reducing a cogging torque.

### BRIEF DESCRIPTION OF THE DRAWINGS

FIG. 1 is a perspective view of a low-cog permanent magnet motor according to a preferable embodiment of the present invention.

FIG. 2 is a perspective exploded view of the low-cog permanent magnet motor according to the preferable embodiment of the present invention.

FIG. 3 is a cross-sectional view of the low-cog permanent magnet motor according to the preferable embodiment of the present invention.

FIG. 4 is an enlarged view of an area 4 in FIG. 3.

### DETAILED DESCRIPTION

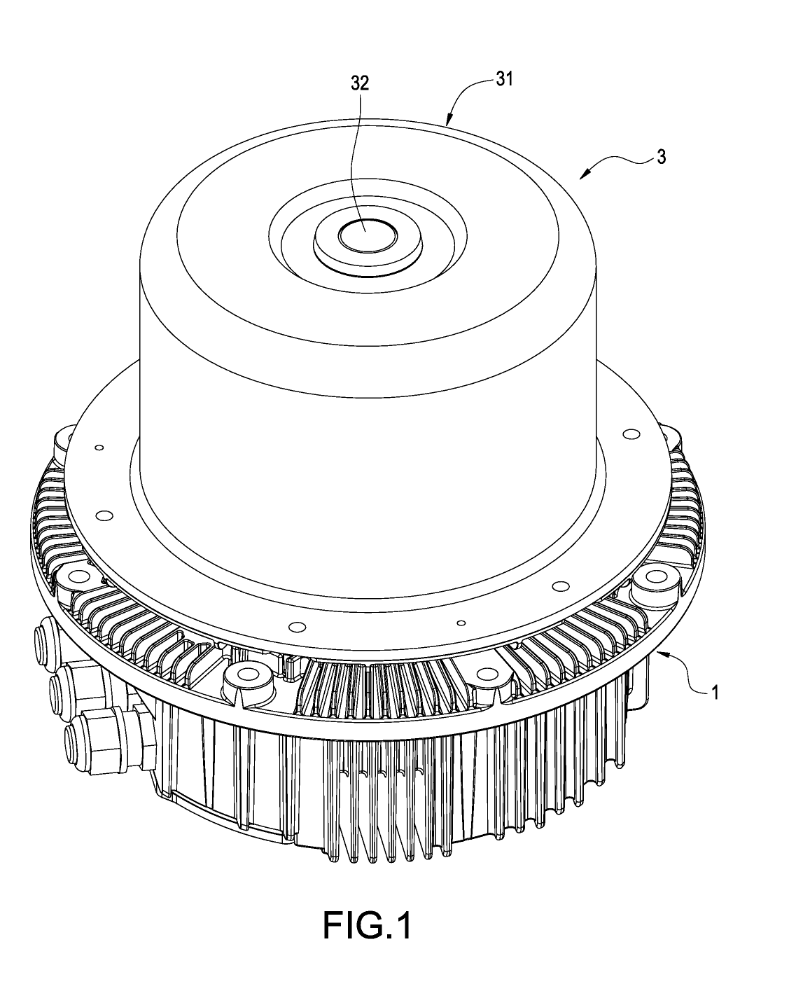

Please refer to FIGS. 1 to 3 which show a low-cog permanent magnet motor according to a preferable embodiment of the present invention. The low-cog permanent magnet includes a base 1, a stator 2, and a rotor 3.

According to the present embodiment, the stator 2 and the rotor 3 are disposed on the base 1, and a shaft sleeve (not illustrated) extends from the base 1.

According to the present embodiment, the stator 2 is made of silicon steel. The stator 2 includes a stator cylinder 22 and a plurality of bobbins 21 extending radially from the stator cylinder 22, and the bobbins 21 are arranged in a radial pattern. In order to meet the requirements for a three-phase operation, the number of the bobbins is preferably a multiple of 3. In the present embodiment, the number of the bobbins is twelve. An end portion of each of the bobbins 21 extends in a circumferential direction of the stator 2 to form a pole shoe 23. The pole shoes 23 are arranged in a ring shape. The stator cylinder 22 encloses the shaft sleeve to fix the stator 2 to the base 1.

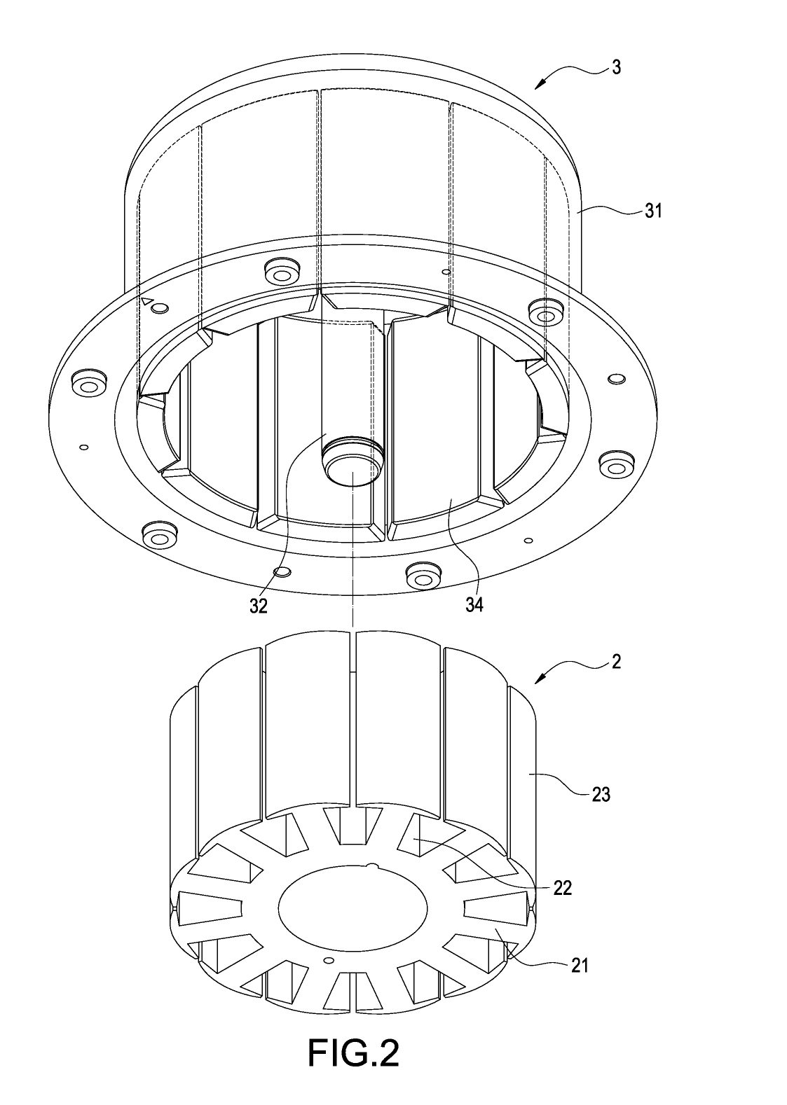

Referring to FIGS. 2 to 4, the rotor 3 includes an outer sleeve 31, a rotation axis 32, and an even number of permanent magnets 34. The rotation axis 32 and the outer sleeve 31 are coaxially disposed. One end of the rotation axis 32 is fixedly connected to an inner wall of the outer sleeve 31, the rotation axis 32 is inserted in the shaft sleeve, so that the outer sleeve 31 encloses the stator 2, and the rotor 3 is rotatable about the rotation axis 32. Each of the permanent magnets 34 is arc-shaped, so each of the permanent magnets 34 includes an inner surface 342 facing the stator 2 and an outer surface 343 opposite to the inner surface 342, and the inner surface 342 and the outer surface 343 are arc-shaped. The outer surface 343 of the permanent magnet 34 is attached to the inner wall of the outer sleeve 31, and the permanent magnets 34 are arranged in a ring shape. The inner surface 342 and the outer surface 343 of each of the permanent magnets 34 are of different magnetic polarity, and the adjacent two permanent magnets 34 are of opposite magnetic polarity.

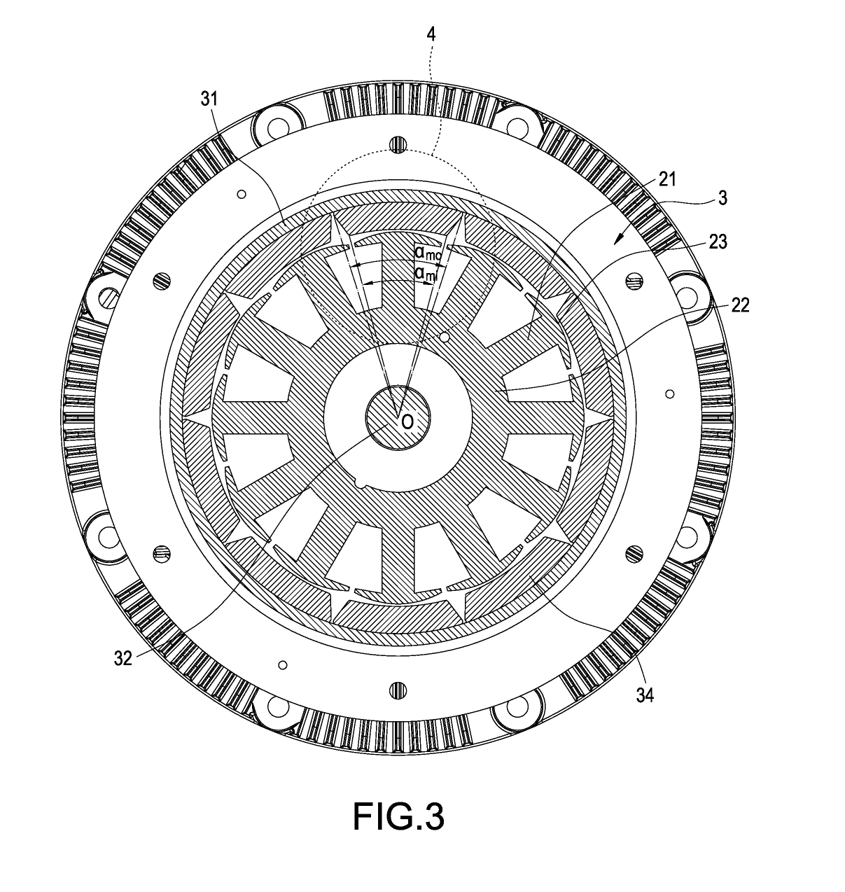

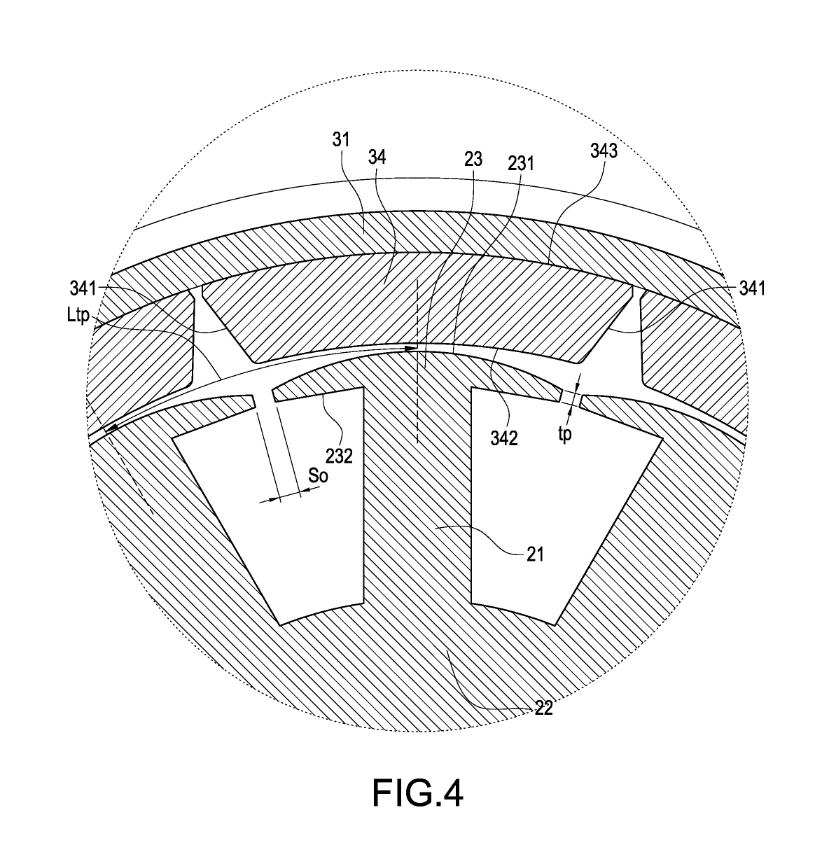

Referring to FIGS. 3 and 4, in order to reduce a cogging torque when the rotor 3 rotates with respect to the stator 2, the pole shoe 23 and the permanent magnet 34 of the present invention are shaped as follows.

Each of the pole shoes 23 includes an outer curved surface 231 facing the inner wall of the outer sleeve 31 and includes an inner arc surface 232 opposite to the outer arc surface 231. An arc center of the outer arc surface 231 is arranged off from a center O of the stator 2, and a radius of the outer arc surface 231 is smaller than a radius of the inner arc surface 232 (the inner surface 232 can be a plane with an infinite radius). A thickness tₚ of an edge of the pole shoe 23 is smaller than a thickness of a central portion of the pole shoe 23, so a magnetic field of the edge of the pole shoe 23 is relatively weaker than that of the central portion of the pole shoe 23. Accordingly, when the edge of the pole shoe 23 departs from the permanent magnet 34, the pole shoe 23 is prevented from being pulled back by the attraction of the permanent magnet 34, thereby reducing a cogging torque during the departure process.

An arc length of each of the outer arc surfaces 231 is an odd multiple of a distance Sₒ between the adjacent two pole shoes 23. The distance Sₒ of the adjacent two pole shoes 23 is 0.3 to 3 times than a thickness tₚ of the edge of the pole shoe 23. In order to optimize the design of a shape of the stator 2, a coefficient N₁ is defined by N₁=3Sₒ/tₚ to indicate a relation which the distance Sₒ between the pole shoes 23 is related to the thickness tₚ of the edge of the pole shoe 23, so N₁ ranges from 1 to 9.

Preferably, an arc length Lₜₚ between end portions of the adjacent two bobbins 23 is in the range of 11 to 19 times the distance Sₒ between the adjacent two pole shoes 23. In order to optimize the design of a shape of the stator 2, a coefficient N₂ is defined by N₂=Lₜₚ/Sₒ to indicate a relation which the arc length Lₜₚ between the end portions of the adjacent two bobbins 23 is related to the distance Sₒ between the adjacent two pole shoes 23, so N₂ ranges from 11 to 19.

Each of two lateral edges of the permanent magnet 34 forms a chamfered corner 341. Therefore, a central angle αₘₒ subtended by the outer surface 343 of the permanent magnet 34 is larger than a central angle αₘᵢ subtended by the inner surface 342 of the permanent magnet 34. Accordingly, the magnetic field of the edge of the permanent magnet 34 is relatively weaker than the magnetic field of the central portion of the permanent magnet 34. Accordingly, when the edge of the pole shoe 23 departs from the permanent magnet 34, the pole shoe 23 is prevented from being pulled back by the attraction of the permanent magnet 34, thereby reducing the cogging torque during the departure process. The central angle αₘᵢ subtended by the inner surface 342 is preferably 0.5 to 0.9 times than the central angle αₘₒ subtended by the outer surface 343, and the chamfered corner 341 has an optimal shape by this arrangement.

An electrical angle indicates a phase angle change of the magnetic field and is a product obtained by multiplying a number of the pairs of the permanent magnets 34 by a mechanical angle. In the present embodiment, there are preferably five pairs of the permanent magnets 34. All of the central angles αₘₒ subtended by the outer surfaces 343 of the permanent magnets 34 together form a total mechanical angle of 360 degrees, and the outer surfaces 343 together form a total electrical angle of 1800 degrees. The electrical angle of each inner surface 342 preferably ranges from 90 to 150 degrees. That is to say, the central angle αₘᵢ subtended by the inner surface 342 of the permanent magnet 34 preferably ranges from 18 to 30 degrees. In order to optimize the design of a shape of the permanent magnet 34, a coefficient N₃ is defined by N₃=6 αₘᵢ/αₘₒ to indicate a relation which the central angle αₘₒ of the outer surface 343 is related to the central angle αₘᵢ of the inner surface 342, so N₃ ranges from 3 to 5.

According to the ten-pole twelve-bobbin motor exemplified in the present embodiment, an outer diameter of the stator 2 is 150 mm, and the distance Sₒ of the pole shoe 23 is 3 mm, according to the design requirement. By preferably choosing N₁=5, the thickness tₚ of the edge of the pole shoe 23 is obtained as 1.8 mm. By preferably choosing N₂=11, the arc length Lₜₚ between the end portions of the adjacent two pole shoes 23 is 19.8 mm. According to the above-mentioned dimensions, the shape of the pole shoe 23 is decided. Since there are five pairs of the permanent magnets 34 disposed in the rotor 3, the central angle αₘₒ subtended by the outer surface 343 of the permanent magnet 34 is 36 degrees (i.e. αₘₒ=360/(2*5)). By preferably choosing N₃=5 to meet the design requirement, the central angle αₘᵢ subtended by the inner surface 342 is 30 degrees.

According to the low-cog permanent magnet of the present invention, the magnetic field of the edge of the pole shoe 23 or the permanent magnet 34 is weakened by reducing the thickness of the edge of the pole shoe 23 or the permanent magnet 34. Consequently, when the rotor 3 rotates to a position that the edge of the pole shoe 23 is corresponding to the edge of the permanent magnet 34, the magnetic attraction between the edges of the both is relatively weaker than other positions, so the permanent magnet 34 moves smoothly along a rotation direction of the rotor 3 to a position of the next pole shoe 23, thereby reducing the cogging torque.

It is to be understood that the above descriptions are merely preferable embodiments of the present disclosure and are not intended to limit the scope of the present disclosure. Equivalent changes and modifications made in the spirit of the present disclosure are regarded as falling within the scope of the present disclosure.

What is claimed is:

1. A motor comprising:
a stator including a plurality of bobbins, the bobbins being arranged in a radial pattern, an end portion of each of the bobbins forming a pole shoe, the pole shoes being arranged in a ring shape; and
a rotor including an outer sleeve which encloses the stator and including an even number of permanent magnets attached to an inner wall of the outer sleeve, the permanent magnets being arranged in a ring shape, wherein each of the pole shoes includes an outer curved surface facing the inner wall of the outer sleeve and includes an inner arc surface opposite to the outer arc surface, and a radius of the outer arc surface is smaller than a radius of the inner arc surface.

2. The motor of claim 1, wherein an arc center of the outer arc surface is arranged off from a center of the stator.

3. The motor of claim 1, wherein the number of the bobbins is a multiple of 3.

4. The motor of claim 1, wherein an arc length of each of the outer arc surfaces is an odd multiple of a distance between the adjacent two pole shoes.

5. The motor of claim 1, wherein a distance between the adjacent two pole shoes is 0.3 to 3 times than a thickness of an edge of the pole shoe.

6. The motor of claim 1, wherein an arc length between end portions of the adjacent two bobbins is 11 to 19 times than a distance between the adjacent two pole shoes.

7. The motor of claim 1, wherein each of the permanent magnets is arc-shaped, each of the permanent magnets includes an inner surface facing the stator and an outer surface opposite to the inner surface, and the inner surface and the outer surface are arc-shaped, and a central angle subtended by the outer surface is greater than a central angle subtended by the inner surface.

8. The motor of claim 7, wherein the central angle subtended by the inner surface is 0.5 to 0. 9 times than the central angle subtended by the outer surface.

9. The motor of claim 7, wherein an electrical angle of the outer surface is 180 degrees.

10. The motor of claim 7, wherein an electrical angle of the inner surface is in the range of 90 to 150 degrees.

11. The motor of claim 7, wherein the inner surface and the outer surface of each of the permanent magnets are of different magnetic polarity.

12. The motor of claim 11, wherein the adjacent two permanent magnets are of opposite polarity.
